(19) United States
(12) Patent Application Publication
(10) Pub. No.: US 2006/0188835 A1
(43) Pub. Date: Aug. 24, 2006

(54) Multi-wavelength dental light curing gun

(76) Inventors: Rich Nagel, West Chicago, IL (US); Byoung I. Suh, Oak Brook, IL (US)

Correspondence Address: ICE MILLER LLP, ONE AMERICAN SQUARE, SUITE 3100, INDIANAPOLIS, IN, 46282-0200, US

(21) Appl. No.: 11/062,371

(22) Filed: Feb. 22, 2005

(51) Int. Cl. A61C 1/00

(52) U.S. Cl. 433/29

(57) ABSTRACT

Multi-wavelength dental light curing guns or devices are disclosed. The multi-wavelength dental light curing guns or devices include a user handle attached to a light source support. A first light source is mounted on the light source support and is operable to project a first light beam of a first wavelength along a first light path, the first wavelength being capable of initiating polymerization of a first photopolymerizable dental composition. A second light source is mounted on the light source support and is operable to emit a second light beam of a second wavelength along a second light path, the second wavelength being capable of initiating polymerization of a second photopolymerizable dental composition different than the first dental composition, wherein the first light path does not intersect the second light path.

### FIELD OF THE INVENTION

The present invention relates generally to dental instruments. In particular, the invention relates to a multi-wavelength dental light curing gun or device that is operable to generate light beams having different wavelengths capable of initiating polymerization of different photopolymerizable dental compositions.

### BACKGROUND OF THE INVENTION

Modern dental restoration procedures often require use of various resin-containing materials that are capable of undergoing hardening or curing reactions as part of the process for preparing or restoring the tooth surface, or for attaching orthodontic or other dental appliances to the tooth. For example, dental etchants, primers, adhesives, composites and sealers may be used as part of the foregoing dental procedures. Such dental compositions often contain compounds that harden by polymerization reactions initiated by application of a strong light source to the composition. Dental professionals typically employ a dental light curing gun to direct a light beam having a specific range of wavelengths of visible light onto the resin to initiate polymerization of the dental composition.

Many prior art dental light curing guns use visible light sources that require higher levels of energy to power them and are energized via traditional power outlets. Examples of such light sources include Quartz-Tungsten-Halogen (QTH) lamps and plasma arc lamps. Such QTH light sources often consume as much as 100 watts of power during the curing operation. Plasma arc lamps may employ between 300 and 500 watts of power during the curing process. Dental light curing guns employing these types of light sources often have restrictive cords or light pipes extending from their hand pieces to their bases that can interfere with a dental professional's ability to manipulate and operate the dental light curing gun.

With advances in technology, dental manufacturers have begun investigating the use of light emitting diodes (LED) as dental light curing gun light sources. LEDs are initially attractive in that they typically consume far less energy than other traditional light sources and can be energized via batteries thereby eliminating the need for cumbersome cords.

Initiating polymerization of a particular photopolymerizable dental composition typically requires the use of a light beam having a minimum intensity and specific wavelength or narrow range of wavelengths chosen in view of the photoinitiator compound(s) and the photopolymerizable compounds present in the dental composition. As a result, different dental compositions may require light beams having different wavelengths to initiate the polymerization process. For example, the well-known photoinitiator camphorquinone (CQ) requires the use of a light beam having a wavelength of about 470 nm, while another known polymerizable dental material photoinitiator, TPO (2,4,6-Trimethyl benzoyl diphenyl phosphine oxide) requires the use of a light beam having a wavelength of about 390 nm. Other compounds employed as dental photoinitiators, such as Igracure 907 and 396, are initiated at light wavelengths of about 405 nm and 440 nm, respectively. Commercially available Daracure 4265, believed to be a combination of TPO and other photoinitiators, has a preferred light initiation wavelength of about 390 nm.

LEDs typically emit light beams having a relatively narrow bandwidth. As a result, a dental light curing gun with a single LED light source adapted to generate a light beam having a narrow range of wavelengths of light cannot be used to cure dental compositions requiring light beams having significantly different wavelengths to initiate the polymerization process.

It has been found that a single five watt blue LED typically has the requisite intensity level and emitted wavelength light for CQ curing and is readily coupled to a light guide, such as for example an optical fiber light guide, for effective clinical curing. Typically a plurality of purple LEDs are employed to produce a light beam having sufficient intensity levels for effective clinical curing. Sometimes as many as fifteen purple LEDs are clustered to produce the requisite light intensity levels. Early adaptations of the Blue LED light curing devices also used an array of discrete LED packages, up to 60 in some cases. The contribution of light from the LEDs located increasingly farther from the center of the array became less because their coupling efficiencies became much lower.

Prior art QTH and plasma arc lamps emit visible light having a relatively wide bandwidth of wavelengths of light that is capable of activating many dental photoinitiator compounds. However, prior art LED dental light curing guns are designed to produce a beam of light having a narrow range of emitted wavelengths of light. Consequently, if a dental professional is in the process of curing two different types of dental compositions requiring light beams having two significantly different wavelengths using at least one prior art LED light curing gun, the dental professional has to purchase, manipulate and maintain at least two separate dental light curing guns, each adapted to produce a light beam of the needed wavelength(s).

One prior art dental light curing gun, the UltraLume 5 (Ultradent, South Jordon, Utah), is configured to simultaneously emit light beams having two different wavelengths. The light source includes a single blue high intensity LED surrounded by a plurality four of lower intensity purple LEDs. The purple LEDs are arranged in a rectangular pattern in the corners of the rectangle around the centrally located blue LED. In addition to being wasteful in terms of unnecessary energy usage and shortened battery lifetime to drive the LED light source that is not being utilized to initiate polymerization, this configuration creates a divergence of the light beams emitted from the purple LEDs, resulting in a lower light intensity on the target dental composition.

Another prior art device, the TransCure device sold by Kinnetic Instruments, Inc., provides a single power source comprising a battery and handle into which different light generating mechanisms may be inserted. The light mechanisms comprise different wavelength light emission sources coupled to removable light probes. In order to select different wavelengths of emitted light, the dental practitioner must remove the light source and probe, and replace it with a different light source and probe. This requires the practitioner to purchase and maintain multiple light-generating assemblies, and is similar in cost and space requirements to using multiple traditional light curing guns. In practice, the TransCure also appears to deliver low curing intensities.

It is desirable, therefore, to provide a dental light curing devices and guns for curing different dental compositions requiring the use of light beams having different wavelengths that overcomes one or more of the prior art limitations described above.

### SUMMARY OF THE INVENTION

One aspect of the invention provides a multi-wavelength dental light curing device including a user handle portion attached to a light source support portion. A first light source is mounted on the light source support and is operable to project a first light beam of a first wavelength along a first light path, the first wavelength being capable of initiating polymerization of a first photopolymerizable dental composition. A second light source is also mounted on the light source support portion and is operable to emit a second light beam of a second wavelength along a second light path, the second wavelength being capable of initiating polymerization of a second photopolymerizable dental composition different than the first dental composition, wherein the first light path does not intersect the second light path.

Another aspect of the invention provides a multi-wavelength dental light curing gun including a user handle portion attached to a light source support portion. The light source support portion includes a first arm and a second arm. The first arm extends away from the user handle, preferably at an ergonomic angle, and terminates in a first probe connection end. The second arm extends away from the user handle, preferably at an ergonomic angle, and terminates in a second probe connection end. A first light source is mounted on the light support and is optically connected to the first probe connection end, and a second light source is mounted on the light support and is optically connected to the second probe connection end. First and second light probes are preferably removeably connected at their bases to their respective probe connectors on the light support and emit a focused beam of light at their opposite ends. The first light source is operable to emit a light beam having a first wavelength to the first light connector and into the base of the first light probe and outward from the other end of the light probe forming an emitted light beam having a longitudinal axis in a first direction and where the emitted intensity and wavelength of the beam is capable of initiating polymerization of a first photopolymerizable dental composition. The second light source is operable to emit a light beam having a second wavelength to the second connector and into and out of the second light probe forming an emitted light beam having a longitudinal axis in a second direction and where the emitted intensity and wavelength of the second beam is capable of initiating polymerization of a second photopolymerizable dental composition different than the first dental composition. Preferably, the path of the first and second light beams does not intersect. Preferably, one or both light sources comprise one or more light emitting diodes. Preferably, the first and second light probes are located at positions on the light support such that they extend in substantially parallel or opposite directions. Also preferable, the light curing devices of the present invention include switch and/or probe connection mechanisms that permit selective operation of one of the light sources and, optionally, selective or automatic deactivation of the other light source during operation of the selected light source or connected probe.

### BRIEF DESCRIPTION OF THE DRAWINGS

The present invention is illustrated by way of example and not limited in scope to the accompanying figures, in which like references indicate similar elements, and in which:

FIG. 1 is a perspective view of one embodiment of a multi-wavelength dental light curing gun system in accordance with the principles of the present invention;

FIG. 2 is a view of a first light source consisting of a blue LED light source module in accordance with the principles of the present invention;

FIG. 3 is a view of a second light source consisting of a purple LED light source module in accordance with the principles of the present invention;

FIG. 4 is an elevational top view of one embodiment of a multi-wavelength dental light curing gun 14 in accordance with the principles of the present invention;

FIG. 5 is a schematic block diagram of an embodiment of a multi-wavelength dental light curing gun in accordance with the principles of the present invention;

FIG. 6 is a perspective view of an embodiment of multi-wavelength dental light curing gun with an attached light probe in accordance with the principles of the present invention;

FIG. 7 is a perspective view of another embodiment of a multi-wavelength dental light curing device in accordance with the principles of the present invention;

FIG. 8 is a perspective view of another embodiment of a multi-wavelength dental light curing gun in accordance with the principles of the present invention; and

FIG. 9 is a perspective view of another embodiment of a multi-wavelength dental light curing device in accordance with the principles of the present invention.

### DETAILED DESCRIPTION OF THE PREFERRED EMBODIMENTS

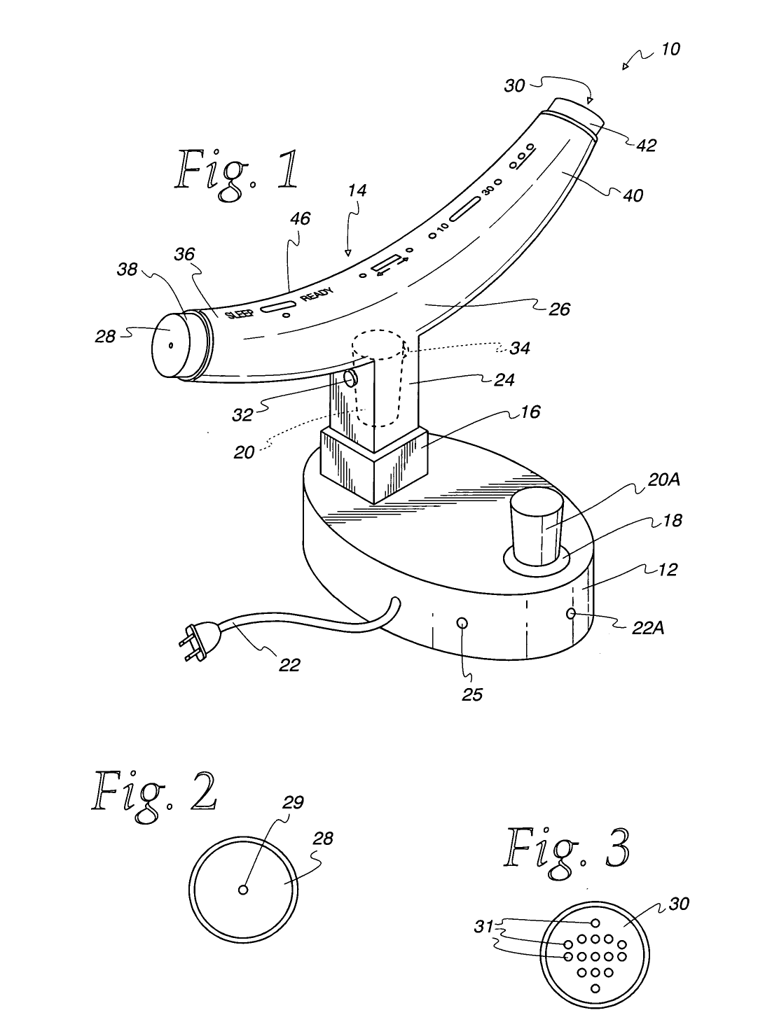

Referring to FIG. 1, a perspective view of one embodiment of a multi-wavelength dental light curing system 10 in accordance with the principles of the present invention is shown. The multi-wavelength dental light curing system 10 generally includes a dental light curing light curing device base 12 and a multi-wavelength dental light curing gun 14.

A preferred embodiment of base 12 includes a combination dental light curing gun holder/battery charger 16 and a spare battery charger 18. In one embodiment, the battery 20 is a nickel metal hydride rechargeable battery. The battery 20, preferably contained within the multi-wavelength dental light curing gun 14, can be recharged while it is stored within the dental light curing gun holder/battery charger 16. A second battery 20A can be externally charged via the spare battery charger 18. The second battery 20A is provided so that one of the batteries can be in standby charge mode while the other battery 20 is being used. The base 12 includes a power cord 22 for connection to a power source, preferably a traditional 120 v/220 v power outlet, when recharging one or more of the rechargeable batteries 20 and 20A is desired. A DC power source receptacle 22A for charging battery 20 or 20A may also optionally be included in base 12, and optional satellite battery charging power outlet 25 may also be provided in base 12.

In another embodiment, base 12 includes a combined dental light curing gun holder/battery charger 16 as the sole battery charging means. In another embodiment base 12 includes a passive dental light curing gun holder 16 and a separate battery charger 18. In this embodiment, the battery 20 must be removed from the multi-wavelength dental light curing gun 14 and placed in the battery charger 18 to be recharged.

The multi-wavelength dental light curing gun 14 is designed such that the battery 20 can be easily attached to the multi-wavelength light dental light curing gun 14. In one embodiment, the battery 20 is a snap fitted into the multi-wavelength dental light curing gun 14. In another embodiment, the battery 20 is inserted into the multi-wavelength dental light curing gun 14 and secured with a quarter turn twist to secure the battery 20 in place. In another embodiment, battery 20 and an appropriate shaped housing may comprise a portion of the handle portion of the light curing gun and is removeably attached to a portion of handle 24 or directly to light support portion 26 of the device.

It typically takes two hours to fully recharge a battery 20. A fully charged battery 20 typically runs for approximately forty minutes. A single curing procedure typically requires four minutes. A fully charged battery 20 can be used to effectively perform at least ten four minute procedures.

In another embodiment, one or more lithium batteries are used to power the multi-wavelength dental light curing gun 14. While a number of embodiments of a multi-wavelength dental light curing systems 10 powered by a number of different types of batteries has been described, multi-wavelength dental light curing guns 14 or other dental multi-wavelength light curing dental devices powered by alternative power sources are also considered to be within the scope of the invention. Traditional 120 v/220 v power supplies could also be used with appropriate cords connecting the power source to base 12 and handle 24 of the light curing device of the present invention.

The multi-wavelength dental light curing gun 14 includes a user handle portion 24, a light source support portion 26, a first light source 28 and a second light source 30. In one embodiment, the user handle 24 is generally elongated and rectangular in shape. In one embodiment, the user handle 24 is rigidly affixed to the light source base 26 at an ergonomic angle with respect to the light source base 26 such that that the multi-wave dental light curing gun 14 can be used with ease with either the first light source 28 or the second light source 30.

In another embodiment, the user handle 24 is pivotally attached to the light source base 26 and is selectively pivotable between at least a first position and a second position. When the user handle 24 is locked into the first position, the user handle 24 is preferably positioned at an ergonomic angle with respect to the light source base 26 to facilitate use of the first light source 28. When the user handle 24 is locked into the second position, the user handle 24 is preferably positioned at an ergonomic angle with respect to the light source base 26 to facilitate use of the second light source 30. It should be noted that while a number of user handles 24 have been described, alternative forms of user handles 24 and handle positioning mechanism are also considered to be within the scope of the invention.

The user handle 24 preferably includes a first light source trigger 32 and a second light source trigger 34. The first and second light source triggers are communicatively coupled to the controller 60. (See FIGS. 1 and 5) When the first light source module 28 is selected for operation, depressing the first light source trigger 32 activates the first light source 28. When the second light source module 30 is selected for operation, depressing the second light source trigger 34 activates the second light source 30. Alternatively, a single switching mechanism can be supplied that provides one off and two on positions, one on position providing power to the first light source and the other on position providing power to the second light source. More preferably, the switching mechanism also provides for automatic deactivation of the non-selected light source to prevent accidental activation of the second light source, extending its service light and preventing accidental discharge of the non-selected light source to the dental practitioner, his or her assistant(s) and/or toward the eyes or areas of the patient not undergoing treatment. In some preferred embodiments, pivoting of the handle portion 24 acts as the switching mechanism and/or as the selective light deactivation mechanism in the light curing device

As shown in FIG. 1, the light source base 26 preferably includes a first arm 36 extending in a first direction and terminating in a first light source connection end 38 and a second arm 40 extending in the opposite direction and terminating in a second light source connection end 42. The first light source 28 is mounted on the first connection end 38 and when activated projects a light beam having a first wavelength along a first light path. The first wavelength is capable of initiating polymerization of a first photopolymerizable dental composition.

The second light source module 30 is mounted on the second connection end 42 and when activated projects a beam of light having a second wavelength along a second light path. The second wavelength is capable of initiating polymerization of a second photopolymerizable dental composition that is different from the first photopolymerizable dental composition. The first and second light paths are separate and distinct from each other such that there is no overlap between the first and second light paths. In one embodiment, one or both of the light sources 28, 30 are releasably mounted on the light source base 26. In another embodiment, one or both of the light sources 28, 30 are permanently affixed to the light source base 26.

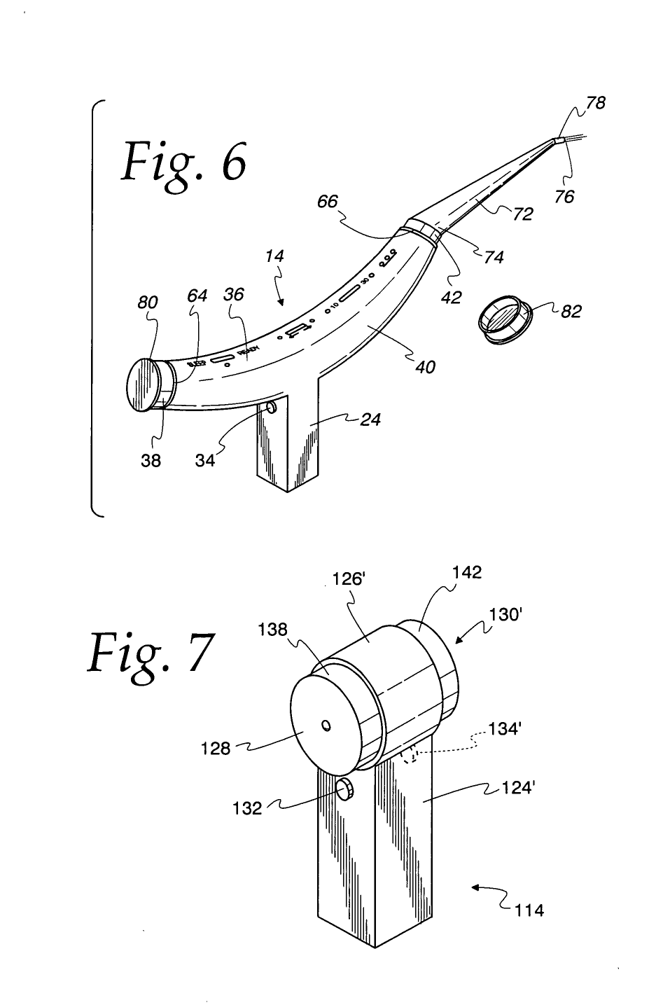

More preferably, one or both of the first and second connection ends 38, 42 comprise light probe connection mechanisms. As shown in FIG. 6, a light probe 72 can be attached to a probe connection ends 38, 42 via their respective probe attachment mechanism to optically couple the light source 28, 30 to the light probe 72. The light probe 72 functions to guide the light beam generated by the light source 28, 30 from the light source to the point of application on a dental composition.

First and second probe detectors 64, 66 are mounted on the first and second probe connection ends 38, 42, respectively. The first and second probe detectors 64, 66 are communicatively coupled to a controller 60 and detect when a light probe 72 is attached to one of the first and second probe connection ends 38, 42.

Referring to FIG. 2 a view of a first light source 28 consisting of a blue light LED module in accordance with the principles of the present invention is shown. The blue LED module includes a single high intensity blue LED 29. An example of a blue LED module includes a five watt LumiLed® LED package. The blue LED module generates a light beam having a wavelength of approximately 470 nm. This wavelength has been found to be optimal for curing or hardening photopolymerizable dental compositions employing CQ as the photoinitiator for such polymerization. Such dental compositions include many dental composites and adhesives, and dental sealants and primers.

Referring to FIG. 3 a view of a second light source 30 consisting of a purple light LED module in accordance with the principles of the present invention is shown. The purple LED module includes an array of purple LEDs 31. In one embodiment, fifteen LEDs are arrayed to achieve the intensity levels necessary to achieve efficient curing of specific dental compositions. The wavelength of the light beam generated by the purple LED module ranges from approximately 370 nm to approximately 410 nm. Such wavelengths are typically optimal for curing or hardening of dental compositions employing TPO or TPO-containing photoinitiators in the dental compositions, or compositions employing Igracure 907 or 396 as the photoinitiator. For example, BISCOVER dental sealant sold by Bisco, Inc., Schaumburg, Ill. cures well at 390 nm. While a number of different light source modules have been described, alternative light source modules capable of emitting light beams having different wavelengths are also considered to be within the scope of the invention. For example, if an external 120 v/220 v power supply is utilized, one or more QHT or other traditional non-LED light sources could be employed in the multi-wavelength devices according to the present invention.

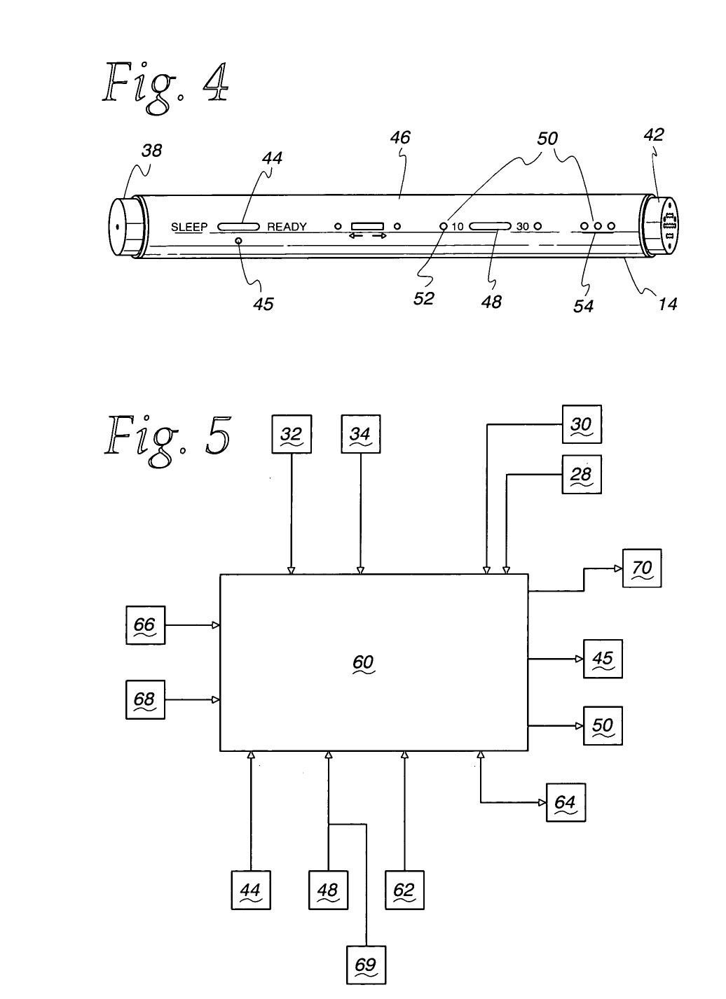

Referring to FIG. 4 an elevational top view of one embodiment of the multi-wavelength dental light curing gun 14 in accordance with the principles of the present invention is shown. The multi-wavelength dental light curing gun 14 can be placed in one of two modes, an off or sleep mode and a ready mode. A mode select button 44 is provided on an upper surface 46 of the light source base 26 to selectively place the multi-wavelength dental light curing gun 14 in one of the two modes. When not in use, the dental gun 14 can be placed in sleep mode to conserve power. The multi-wavelength dental light curing gun 14 is enabled for operation when placed in ready mode. When the multi-wavelength dental light curing gun is placed in ready mode, an indicator LED 45 is lit. It should be noted that while a number of different modes have been described, alternative embodiments with a fewer or greater number of modes are also considered to be within the scope of the invention. In one embodiment, the mode select button 44 consists of a membrane button, however other types of mode select buttons 44 are also considered to be within the scope of the invention. In one embodiment, the indictor LED 45 also operates to provide an indication of available battery power.

In one embodiment, an exposure time selector 48 is provided on the upper surface 46 of the multi-wavelength dental light curing gun 14. The exposure time is the period of time that that the selected light source 28, 30 is activated once the appropriate light source trigger 32, 34 is actuated. The exposure time selector 48 permits a dental professional to select one of a number of pre-defined exposure times. In one embodiment, the exposure time selector 48 can be used to select one of two different exposure times. In one embodiment, the two selectable exposure times are a ten second exposure time and a thirty second exposure time. In one embodiment, the last selected exposure time is saved in a memory 69 when the multi-wavelength dental light curing gun 14 is taken out of ready mode. The saved exposure time appears as the default exposure time when the multi-wavelength dental light curing gun 14 is placed back in ready mode.

In one embodiment, an exposure time indicator 50 is provided on the upper surface 46 of the multi-wavelength dental light curing gun 14. The exposure time indicator 50 includes a single LED 52 positioned on one side of the exposure time selector 48 to provide an indication of elapsed exposure time when the ten second exposure time is selected and a set of three LEDs 54 is positioned on the other side of the exposure time selector 48 to provide an indication of elapsed exposure time when the thirty second exposure time is selected.

Referring to FIG. 5 a schematic block diagram of an embodiment of the multi-wavelength dental light curing gun 14 in accordance with the principles of the present invention is shown. The multi-wavelength dental light curing gun 14 includes a controller 60 communicatively coupled to the first and second light sources 28, 30, first and second light source triggers 32, 34, the mode select button 44, a battery power sensor 62, the indicator LED 45, the exposure time selector 48, the exposure time indicator 50, an exposure timer 64, first and second probe detectors 66, 68, memory 69 and a alarm 70.

The multi-wavelength dental light curing gun 14 can be placed in one of a sleep mode and a ready mode. The user makes a selection using the mode selection button 44. Based on the input provided via the mode selection button, the controller 60 responsively places the multi-wavelength dental light curing gun 14 in the selected mode. In sleep mode, the controller 60 selectively powers off different components of the multi-wavelength dental gun 14 to minimize power consumption and then the controller 60 places itself in sleep mode. In ready mode, the controller 60 wakes itself up from sleep mode and powers up all of the components necessary to prepare the dental gun 14 for operation. The controller 60 lights the indicator LED 45 when the multi-wavelength dental gun 14 is placed in ready mode.

In one embodiment, the battery power sensor 62 senses the power remaining in the battery 20. When in ready mode, the controller 60 monitors the battery power sensor 62 and responsively powers the indicator LED 45. If the battery 20 is operating at 85% capacity or better, the indictor LED 45 remains continuously lit. If the battery 20 is operating below 85% or at 70%, the indicator LED 45 flashes on for one second and remains off for three seconds. This cycle is repeated while the battery 20 remains within the described range. If the battery 20 is operating below 70%, the indicator LED 45 flashes on for one second and then off for one second. This cycle is repeated until the battery 20 reached a discharged state.

Preferably each of the first and second connection ends 38, 42 include corresponding first and second probe connection attachment mechanisms and corresponding first and second probe detectors 66, 68. The probe connection mechanism can be any suitable means for optically connecting light probe 72 to the first light source 28 or second light source 30, such as snap fit connectors, friction fit connectors, or twist fit or screw fit connectors. Preferably the connector permits ready attachment and detachment of the light probe, facilitating movement of the light probe between the light sources and cleaning of the probe as needed during treatment and between uses on different patients. The controller 60 also preferably monitors each of the first and second probe detectors 66, 68. When a light probe 72 is connected to the first probe connection mechanism, the first probe detector 66 detects the attachment of the light probe 72 at the first probe connection end 38 and the controller 60 responsively enables operation of the first light source module 28 and, preferably, also disables operation of the second light source module 30. Upon actuation of the first light source trigger 32 by a dental professional, the first light source module 28 emits a focused light beam that can be directed to the composition being applied to dental surface undergoing restoration or to the dental or orthodontic appliance and related dental surface being treated with the applied composition and polymerizing the composition and any related appliance in place.

Similarly, when a light probe 72 is attached to the second probe connection mechanism, the second probe detector 68 detects the attachment of the light probe 72 at the second probe connection end 42. The controller 60 responsively enables operation of the second light source module 30 and, preferably, also disables operation of the first light source 28. Upon actuation of the second light source trigger 34 by a dental professional, the second light source module 30 emits a focused second light beam, enabling the dental or orthodontic professional to treat the dental surface and appliance as indicated above even if the second polymerizable composition that is different that the first applied dental composition in terms of the photoinitiators and possible resins being employed. Alternatively, two light probes may be employed, each connected to one of each of the light sources 28, 30 through their respective connectors 38, 42 along with a switching mechanism that permits selective activation of one light source but not simultaneous operation of both light sources. In this preferred embodiment, the dental or orthodontic professional can simply and rapidly chose between either light source by rotation or pivoting of the handle portion to direct the desired light source toward the target applied dental composition. This type of rapid deployment provided by the present invention may be particularly desirable in dental and orthodontic procedures that require multiple sequential applications of different dental compositions, such as application of crowns or orthodontic brackets adhesives to individual teeth followed by application of suitable sealer compositions to help prevent sensitivity and collection of food particles around the crown or bracket.

In an alternative embodiment, the controller 60 is communicatively coupled to a manual switch. The dental professional selects the desired light source by placing the manual switch in the appropriate position. For example, if a user wishes to use the first light source 28, the user uses the manual switch to select the first light source 28. If the user wishes to use the second light source 30, the user uses the manual switch to select the second light source 30. The controller 60 senses the position of the switch and responsively activates the selected light source 28, 30 while preferably disabling operation of the other light source 28, 30.

The period of time that a light beam is emitted by the selected light source module 28, 30 depends on the exposure time selected by the dental professional via the exposure time selector 48. Based on input supplied via the exposure time selector 48, the controller 60 responsively set the exposure timer 64 in accordance with the selected exposure time. When the ten second exposure time is selected and the multi-wavelength dental light curing gun 14 is in ready mode, the single LED 52 is turned on and remains lit. When the light source trigger 32, 34 associated with the selected light source module 28, 30 is actuated, the LED 52 flashes once every second until the ten seconds of exposure time have elapsed. Once the ten second exposure time has elapsed, the LED remains off for one second, is turned back on and remains lit indicating that the ten second exposure time remains selected.

When the thirty second exposure time is selected, all three of the LEDs 54 are initially turned on and remain lit. When the light source triggers 32, 34 associated with the selected light source module 28, 30 is actuated, one of the end LEDs 54 flashes once every second until ten seconds of exposure time have elapsed and is then turned off. The middle LED 54 then flashes once every second until the next ten seconds of exposure time have elapsed and is then turned off. The final LED 54 in the set then flashes every second until the final ten seconds have elapsed and is then turned off. All three LEDs 54 remains off for one second, are turned back on and then remain lit indicating that the thirty second exposure time remains selected.

In one embodiment, the controller 60 sounds the alarm 70 at the beginning and at the end of an exposure cycle. In one embodiment, the alarm sound is in the form of a beep.

Referring to FIG. 6 a perspective view of an embodiment of the multi-wavelength dental light curing gun 14 with an attached light probe 72 in accordance with the principles of the present invention is shown. In one embodiment, the light probe 72 includes a connection end 74 and a discharge end 76. The connection end 74 is typically provided with an attachment mechanism to allow the light probe 72 to be attached and detached from the multi-wavelength dental light curing gun 14 for purposes of replacement or sterilization. A straight section extends from the connection end 74 and merges into a canted section 78 proximate the discharge end 76. The light probe 72 generally tapers from a relatively larger cross-sectional area at the connection end 74 to a relatively narrower cross-sectional area at the discharge end 76. As the light generated by a light source module 28, 30 travels along the length of the light probe 72, the light intensity is amplified as the cross-sectional area of the light probe 72 gradually decreases. As a result, the light beam generated at the discharge end 76 of the light probe 72 is of a relatively greater intensity than the intensity of the light beam generated by the light source module 28, 30 at the connection end 74. Preferably, one or both light sources 28, 30 are located in close proximity to connection end 74 when probe 72 is connected to the light source and as close as possible along the central axis of probe 72 to further improve the intensity of the light beam emitted from discharge end 76 of the probe. In one embodiment, probe connection caps 80, 82 are provided. When the multi-wavelength dental light curing gun 14 is not in use, the probe connection cap 80, 82 are used to cover the first and second probe connections ends 38, 42. When the dental gun 14 is in use, a probe connection cap 80, 82 is used to cap the probe connection end 38, 42 that is not in use. Capping the probe connections ends 38, 42 when the associated light source module 28, 30 is not in use ensures that debris does not enter the probe connection end areas.

Referring to FIG. 7 a perspective view of another embodiment of a multi-wavelength dental light curing device 114 in accordance with the principles of the present invention is shown. The multi-wavelength dental light curing gun 114 includes a user handle portion 124, a light source support portion 126, a first light source 128 and a second light source 130. The light source support portion 126 extends above the user handle 124. The light source supports 138 and 142 are disposed on the light source support 126 and may be integral to and above or below the surface of the light source support. The first and second light sources 128, 130 are mounted on light supports 138, 142 and may be orientated in any configuration that prevents overlap of their emitted light beams. Preferably, light source supports 128 and 130 are located on opposite sides of support 126. The user handle 124 includes a first light source trigger 132 and a second light source trigger 134. When the first light source module 128 is selected for operation, actuating the first light source trigger 132 activates the first light source module 128. When the second light source module 130 is selected for operation, actuating the second light source trigger 134 activates the second light source module 130. In one embodiment, the mode select button 144, the indicator LED 145, the exposure time selector 148, and the exposure time indicator 150 are disposed on the upper surface 146 of the light source base 126 similar to the configuration shown in FIG. 4.

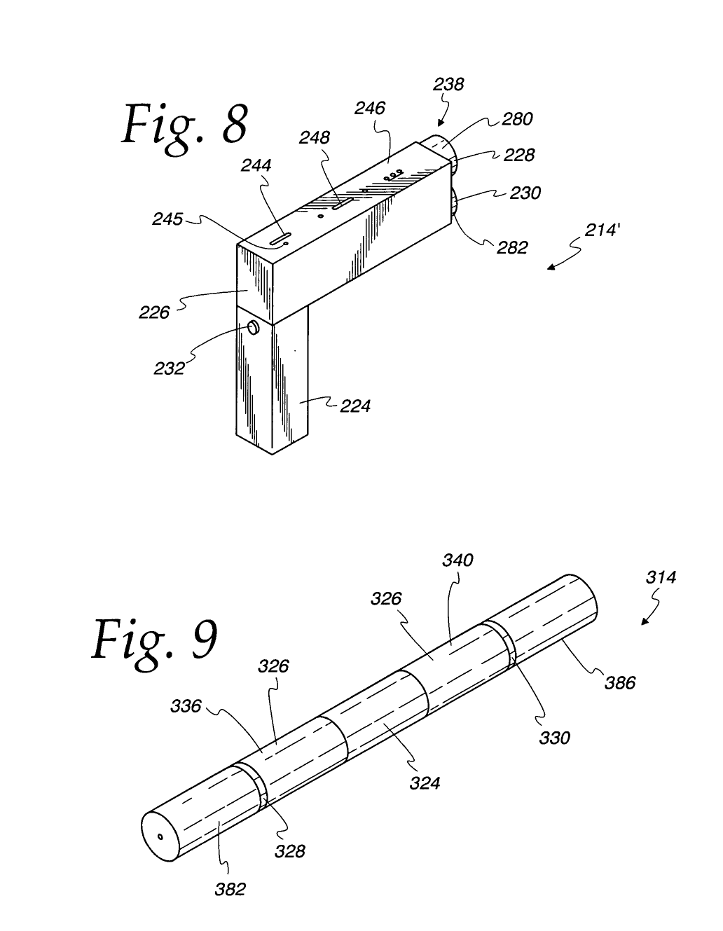

Referring to FIG. 8 a perspective view of another embodiment of a multi-wavelength dental light curing device 214 in accordance with the principles of the present invention is shown. The multi-wavelength dental light curing device 214 includes a user handle portion 224, a light source support portion 226, a first light source 228 and a second light source module 230. The light source support portion 226 includes a single arm 236 that extends away from the user handle 224 and terminates in a probe connection end 238. The user handle 224 creates an ergonomic angle with respect to the light source support 226 to facilitate maneuvering the multi-wavelength dental gun 214. The first and second light sources 228, 230 are both disposed on the probe connection end 238, preferable in and over/under or side-by-side arrangement.

A first probe attachment mechanism 280 is associated with the first light source 228. Attaching a light probe 72 to the first probe attachment mechanism 280 optically couples the first light source 228 to the light probe 72 while attaching a light probe 72 to the second probe attachment mechanism 282 optically couples the second light source 230 to the light probe 72. The user handle 224 includes a single light source trigger 232. When the first light source 228 is selected for operation, actuating the light source trigger 232 activates the first light source 228. When the second light source 230 is selected for operation, actuating the light source trigger 232 activates the second light source 230. In one embodiment, the mode select button 244, the indicator LED 245, the exposure time selector 248, and the exposure time indicator 250 are disposed on an upper surface 246 of the light source base 226. In this embodiment, the first light source module 228 generates a light beam along a first light path and the second light source module 230 generates a light beam along a second light path that is parallel to the first light path. The first light path is distinct and separate from the second light path. There is no overlap between the first light path and the second light path. Alternatively, a selective trigger mechanism may be employed that selects between the first and second light source, dispensing with the need for deactivation of the non-selected light source or attached non-selected light probe.

Referring to FIG. 9 a perspective view of another embodiment of a multi-wavelength dental light curing device 314 in accordance with the principles of the present invention is shown. The multi-wavelength dental light curing device 314 has a generally elongated shape and generally includes a user handle portion 324, a light source support portion 326, a first light source 328 a second light source 330 and optionally first and second light probes 384, 386 that are integral with or removable from the light source support 326.

The light source support 326 includes a first arm segment 336 extending from the user handle portion 324 in one direction and a second arm segment 340 extending from the user handle portion 324 in generally the opposite direction. The first light probe 384 extends from and is integral with the first arm segment 336. Similarly, the second light probe 386 extends from and is integral with the second arm segment 40′″. The first light source 328 is preferably disposed at the junction of where the first arm segment 336 ends and the first light probe begins 384 and is optically coupled to the first light probe 384. Similarly the second light source 330 is preferably disposed at the junction of where the second arm segment 40′″ ends and the second light probe 386 begins and is optically coupled to the second light probe 386. As shown, this embodiment provides a simple device capable of rapid deployment of the first and second light sources by simple 180 degree rotation of the device.

### EXAMPLE 1

Several LED light curing guns were evaluated for their effectiveness to cure a commercial photocurable dental product having a photointiator system with absorption in the wavelength of about 390 nm. BISCOVER™ sealant from Bisco, Inc., Schaumburg, Ill., was applied to samples of previously cured dental composite composition according to the manufacturer's instructions. Two prior art blue LED dental light curing guns, Ultralume 2™ from UltraDent, and Ultra Lite 200E Plus™ from Rolence, were used in the test, along with the previously mentioned Ultra Lume 5™ having blue and purple LEDs arrayed in a rectangular pattern, and Transcure™ having the purple LED light source and probe combination in place in the device's handle/battery portion. Applicants' light curing gun comprised the dual light source device of FIG. 1-6 with the second purple light source comprised of a single high intensity purple LED and a tapered light probe removeably attached to the light source support arm.

The light output end of each light curing gun was brought into a close proximity to the BISCOVER-coated composite, and a series of timed exposures were made until it was determined that BISCOVER had hardened to a surface that was scratch free by a fingernail test. The intensity of the light emitted from each light curing gun was also measured using photocells that were set to active using a series of band pass filters that permit passage of wavelengths of +/−5 nm from the nominal wavelength shown below. The results are reported in Table 1, below.

TABLE 1
Cure Time and Intensities of Light Curing Guns

| | | Intensity | | Intensity | | Intensity | |
|---|---|---|---|---|---|---|---|
| Light Curing Gun | Cure Time | 390 nm | | 400 nm | | 410 nm | |
| Ultralume 2 | No cure | 0 | | 0 | | 0 | |
| Ultra Lite 200 E+ | No cure | 0 | | 0 | | 0 | |
| Present Invention | 10 seconds | 13 | mv | 28 | mv | 36 | mv |
| Ultralume 5 | 15 seconds | 4 | mv | 12 | mv | 16 | mv |
| Transcure | 15 seconds | 5 | mv | 26 | mv | 29 | mv |

As shown above, the Ultralume 2 and Ultra Lite 200E Plus light curing guns having only blue light LEDs as their light sources were unable to cure a dental composition using a photoinitiator system initiated at around 390-410 nm. The light curing gun of the present invention achieved curing in a shorter amount of time and emitted higher intensity of light relative to the other tested light curing guns possessing light emission in the same range of wavelengths.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

What is claimed is:

1. A multi-wavelength dental light curing device, the dental light curing device comprising:
a user handle portion;
a light source support portion attached to the user handle portion;
a first light source mounted on the light source support, the first light source being operable to project a first light beam of a first wavelength along a first light path, the first wavelength being capable of initiating polymerization of a first photopolymerizable dental composition; and
a second light source mounted on the light source support at a position different than the location of the first light source, the second light source being operable to emit a second light beam of a second wavelength along a second light path, the second wavelength being capable of initiating polymerization of a second photopolymerizable dental composition different than the first dental composition, wherein the first light path does not intersect the second light path.

2. The dental light curing gun of claim 1, where in at least one of the light sources comprises a light emitting diode.

3. The dental light curing gun of claim 1, wherein the first and second light sources comprise at least one light emitting diode.

4. The dental light curing gun of claim 1, wherein one of the light sources comprises a single light emitting diode.

5. The dental light curing gun of claim 1, wherein one of the light sources comprises a plurality of light emitting diodes.

6. The dental light curing gun of claim 1, wherein at least one of the light emitting diodes comprises a high-energy light emitting diode.

7. The dental light curing gun of claim 3, wherein the first and second light emitting diodes comprise high-energy light emitting diodes.

8. A dental light curing device of claim 1, wherein the light source support portion comprises a first light support portion attached to the handle portion at a first location, and a second light support portion attached to the handle at a location different than the location of the first light support portion.

9. A dental light curing device of claim 1, wherein the first light support portion is attached to the handle portion at a location substantially opposite of the location of the second light support portion's attachment to the handle portion.

10. The dental light curing device of claim 8, wherein the light source support portion further comprises:
a first arm extending away from the handle portion in a first direction and terminating in a first arm end portion supporting the first light source; and
a second arm extending away from the handle portion in a second direction and terminating in a second arm end portion supporting the second light source.

11. The dental light curing device of claim 1, wherein the first light path is substantially parallel to the second light path.

12. The dental light curing device of claim 1, wherein the user handle portion is rigidly attached to the light source support portion.

13. The dental light curing device of claim 1, wherein the user handle portion is pivotally attached to the light source support portion.

14. The dental light curing device of claim 1, further comprising a light probe optically coupled to one of the light sources.

15. The dental light curing device of claim 14, wherein the light probe is optically coupled to at least one of the light sources and provides a beam of light into the coupled light probe and along the central axis of the coupled light probe.

16. The dental light curing device of claim 1, wherein the light source support portion further comprises a probe attachment mechanism, the probe attachment mechanism being operable to couple a light probe to one of the light sources thereby optically coupling the light source to the light probe.

17. The dental light curing device of claim 16, wherein the probe attachment mechanism is operable to removeably couple one of the light probes to the light source support portion.

18. The dental light curing device of claim 16, wherein the light support portion further comprises two probe attachment mechanisms integral with the light source support portion, one attachment mechanism being operable to optically couple a first light probe to the first light source and the other attachment mechanism operable to couple the second light probe to the second light source.

19. The dental light curing device of claim 16, further comprising a probe connection detector communicatively coupled to the probe attachment mechanism, the probe detector being operable to detect the attachment of a light probe to the probe connection end and responsively enable operation of the connected light source.

20. The dental light curing device of claim 16, further comprising a probe connection detector communicatively coupled to the probe attachment mechanism, the probe detector being operable to detect the attachment of a light probe to the probe connection end and responsively enable operation of the connected light source, while disabling operation of the other light source of the device.

21. The dental light curing device of claim 18, further comprising a first probe connection detector communicatively coupled to the first probe attachment mechanism, and a second probe connection detector communicatively coupled to the second probe attachment mechanism, each detector being operable to detect the attachment of a light probe to the probe connection end and responsively enable operation of the connected light source.

22. The dental light curing device of claim 18, further comprising a first probe connection detector communicatively coupled to the first probe attachment mechanism, and a second probe connection detector communicatively coupled to the second probe attachment mechanism, each detector being operable to detect the attachment of a light probe to the probe connection end and responsively enable operation of the connected light source, while disabling operation of the other light source of the device not connected to a light probe.

23. The dental light curing device of claim 1, further comprising a switch electrically coupled to the first and second light sources and having a first state and a second state, wherein placing the switch in the first state enables operation of the first light source and wherein placing the switch in a second state enables operation of the second light source.

24. The dental light curing device of claim 1, further comprising a switch electrically coupled to the first and second light sources and having a first state and a second state, wherein placing the switch in the first state enables operation of the first light source while disabling operation of the second light source, and wherein placing the switch in a second state enables operation of the second light source while disabling operation of the first light source.

25. The dental light curing device of claim 1, wherein one of the light sources comprises a light emitting diode operable to emit a light beam having a wavelength of approximately 470 nm.

26. The dental light curing device of claim 1, wherein one of the light sources comprises a light emitting diode operable to emit a light beam having a wavelength ranging from approximately 370 nm to approximately 440 nm.

27. The dental light curing gun of claim 1, wherein one of the light sources comprises a light emitting diode operable to emit a light beam having a wavelength of about 390 nm.

28. The dental light curing gun of claim 1, wherein one of the light sources comprises a light emitting diode operable to emit a light beam having a wavelength of about 410 nm.

29. The dental light curing gun of claim 1, wherein one of the light sources comprises a light emitting diode operable to emit a light beam having a wavelength of about 440 nm.

30. The dental light curing gun of claim 1, further comprising a battery power source receiver electrically coupled to the first and second light sources, the battery power source receiver being operable to receive a battery power source and to selectively couple the received battery source to the first and second light sources.

31. The dental light curing gun of claim 1, further comprising a battery power source coupled to at least one of the first and second light sources.

32. The dental light curing gun of claim 1, wherein the battery supply source is located on the light curing gun.

33. The dental light curing gun of claim 1, wherein the battery supply source is located within the light curing gun.

34. A multi-wavelength dental light curing gun, the dental light curing gun comprising:
a user handle portion;
a light source support portion attached to the user handle portion, the light source support portion having a first arm portion and a second arm portion, the first arm portion extending away from the user handle and terminating probe connection end, and a second arm portion extending away from the user handle and terminating in a second probe connection end;
a first light source mounted on the light support, the first light source being operable to emit a first light beam having a first wavelength to the first probe connection end;
a second light source mounted on the light support, the second light source being operable to emit a second light beam to the second probe connection end, the second light beam having a second wavelength different than the wavelength of the first light beam;
a first light probe optically attached by one end to the probe connection end of the first arm, the probe terminating at its other end in a light emitting configuration that emits a beam of light from the first light source and first probe connection end outward from the other probe end and along a first longitudinal axis at a wavelength and intensity sufficient to initiate photopolymerization of a first photopolymerizable dental composition; and
a second light probe optically attached by one end to the probe connection end of the second arm, the probe terminating at its other end in a light emitting configuration that emits a beam of light from the second light source and second probe connection end outward from the other probe end and along a second longitudinal axis at a wavelength and intensity sufficient to initiate photopolymerization of a second photopolymerizable dental composition different than the first dental composition.

35. The dental light curing gun of claim 34, where in at least one of the light sources comprises a light emitting diode.

36. The dental light curing gun of claim 34, wherein the first and second light sources comprise at least one light emitting diode.

37. The dental light curing gun of claim 34, wherein one of the light sources comprises a single light emitting diode.

38. The dental light curing gun of claim 34, wherein one of the light sources comprises a plurality of light emitting diodes.

39. The dental light curing gun of claim 35, wherein at least one of the light emitting diodes comprises a high-energy light emitting diode.

40. The dental light curing gun of claim 36, wherein the first and second light emitting diodes comprise high-energy light emitting diodes.

41. The dental light curing gun of claim 34, wherein one of the light sources comprises a light emitting diode operable to emit a light beam having a wavelength of approximately 470 nm.

42. The dental light curing gun of claim 34, wherein one of the light sources comprises a light emitting diode operable to emit a light beam having a wavelength ranging from approximately 370 nm to approximately 440 nm.

43. The dental light curing gun of claim 34, wherein one of the light sources comprises a light emitting diode operable to emit a light beam having a wavelength of about 390 nm.

44. The dental light curing gun of claim 34, wherein one of the light sources comprises a light emitting diode operable to emit a light beam having a wavelength of about 410 nm.

45. The dental light curing gun of claim 34, wherein one of the light sources comprises a light emitting diode operable to emit a light beam having a wavelength of about 440 nm.

46. The dental light curing gun of claim 34, wherein the first arm is separate from the second arm.

47. The dental light curing gun of claim 34, wherein the second arm extends in a direction from the handle portion that is substantially parallel to the direction of extension of the first arm from the handle portion.

48. The dental light curing gun of claim 46, wherein the second arm extends from the handle portion in a direction that is substantially opposite to the direction of extension of the first arm from the handle portion.

49. The dental light curing gun of claim 48, wherein first arm and second arm extend from the handle portion form a substantially T-shaped configuration.

50. The dental light curing gun of claim 48, wherein first arm and second arm extend from the handle portion form a substantially Y-shaped configuration.

51. The dental light curing gun of claim 34, wherein the user handle portion is rigidly attached to the light source support portion.

52. The dental light curing gun of claim 34, wherein the user handle portion is pivotally attached to the light source support portion.

53. The dental light curing gun of claim 34, further comprising switching mechanism electrically coupled to the first and second light sources and having a first operation state and a second operation state, wherein placing the switching mechanism in the first state enables operation of the first light source, and placing the switching mechanism in the second operation state enables operation of the second light source.

54. The dental light curing gun of claim 34, further comprising a switching mechanism electrically coupled to the first and second light sources and having a first operation state and a second operation state, wherein placing the switching mechanism in the first state enables operation of the first light source and disables operation of the second light source, and placing the switching mechanism in the second operation state enables operation of the second light while disabling operation of the first light source.

55. The dental light curing gun of claim 34, wherein at least one of the probe connection ends comprises an attachment mechanisms that is operable to removeably optically couple a light probe to the connection end of the light support arm.

56. The dental light curing gun of claim 55, wherein both the first and second probe connection ends comprise attachment mechanisms that are operable to removable couple the first and second light probes to their respective connection ends on the light support arms.

57. The dental light curing gun of claim 34, wherein at least one of the probe connection ends further comprises a probe connection detector operable to detect the attachment of a probe to one of the probe connection ends and responsively enable operation of the connected probe and its light source.

58. The dental light curing gun of claim 34, wherein at least one of the probe connection ends further comprises a probe connection detector operable to detect the attachment of a probe to one of the probe connection ends and responsively enable operation of the connected probe and its light source, while disabling operation of the other light source.

59. The dental light curing gun of claim 58, further comprising a first probe connection detector communicatively coupled to the first probe connection end, and a second probe connection detector communicatively coupled to the second probe connection end, each detector being operable to detect the attachment of a light probe to the probe connection end and responsively enable operation of the connected light source, while disabling operation of the other light source of the device that is not connected to a light probe.

60. The dental light curing device of claim 34, wherein the light probe is optically coupled to at least one of the light sources and provides a beam of light into the coupled light probe and along the central axis of the coupled light probe.

61. The dental light curing gun of claim 34, further comprising a battery power source receiver electrically coupled to the first and second light sources, the battery power source receiver being operable to receive a battery power source and to selectively couple the received battery source to the first and second light sources.

62. The dental light curing gun of claim 34, further comprising a battery power source coupled to at least one of the first and second light sources.

63. The dental light curing gun of claim 61, wherein the battery supply source is located on the light curing gun.

64. The dental light curing gun of claim 61, wherein the battery supply source is located within the light curing gun.
